(19) United States
(12) Patent Application Publication
(10) Pub. No.: US 2026/0126421 A1
(43) Pub. Date: May 7, 2026

(54) METHOD OF DETERMINING AN AMOUNT OF WATER IN A SAMPLE USING A PHENOL COMPOUND

(71) Applicant: Honeywell International Inc., Charlotte, NC (US)

(72) Inventors: Roman Neufeld, Gehrden (DE); Thomas Wendt, Stadthagen (DE); Marco Konopatzki, Garbsen (DE)

(73) Assignee: Honeywell International Inc., Charlotte, NC (US)

(21) Appl. No.: 19/350,081

(22) Filed: Oct. 6, 2025

Related U.S. Application Data
(60) Provisional application No. 63/716,809, filed on Nov. 6, 2024.

(51) Int. Cl. G01N 31/16

(52) U.S. Cl. CPC G01N 31/168

(57) ABSTRACT

A method for determining an amount of water in a sample includes the steps of providing a reagent including sulfur dioxide and/or a reaction product of sulfur dioxide and an alcohol and/or an amine, and further including a base, and a solvent; providing the sample including water; and titrating the sample with the reagent to determine the amount of water in the sample, wherein the reagent and/or the sample further includes a certain phenol compound.

### CROSS-REFERENCE TO RELATED APPLICATION

This application claims the benefit of U.S. Provisional application No. 63/716,809, filed on Nov. 6, 2024, the entire content of which is hereby incorporated by reference.

### TECHNICAL FIELD

The present disclosure relates to a method of determining an amount of water in a sample. Specifically, the method includes the use of a particular reagent to titrate a sample, wherein the reagent and/or the sample includes a particular phenol compound.

### BACKGROUND

Measuring water or moisture content in various products can provide useful information for various applications and industries, e.g. product quality control, determination of shelf life of various products, etc. Karl Fischer (KF) titration is an effective technique to determine water content by utilizing the following reactions:

in an alcoholic or protic solution:

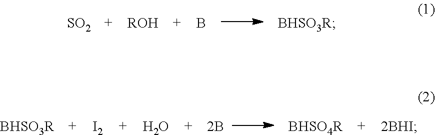

and
in a non-alcoholic or aprotic solution:

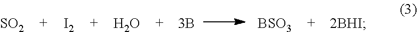

wherein B is a base and ROH is an alcohol.

Unwanted side reactions like the Bunsen reaction (4) and the hydrolysis reaction of SO₃ (5), lead to a deviation from the 1:1 stoichiometry of iodine (I₂) and water which can result in too low water findings with an overall stoichiometry between iodine and water of 1:n, where n=1-2.

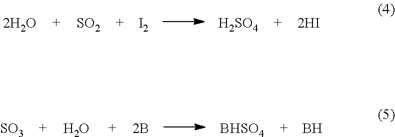

This titration is carried out in two basic forms, namely as a volumetric titration and as a coulometric titration.

KF titrations are typically carried out in an alcoholic solution, e.g. methanol. The use of the alcohol solution helps to stabilize the stoichiometry of the KF reactions by moving the equilibrium to reactions (1) and (2). However, unwanted side reactions (4) and (5) can still occur.

KF titrations also typically utilize reagents such as pyridine in excess to balance the stoichiometry of iodine and water. However, if an excess of pyridine is used, the determinable water can be altered. For example, a pyridine-SO₃ adduct can form, which takes part in a water-consuming side reaction (5) that can falsify the titration results.

Apart from the above, other factors can also influence the accuracy of such titrations. For example, using compromised samples may lead to non-ideal titration conditions such as long stable drift time, which can affect the ability to determine water content accurately.

Accordingly, there remains an opportunity to develop a KF titration method that provides highly accurate and efficient titrations with a variety of samples.

### BRIEF SUMMARY

This disclosure provides a method for determining an amount of water in a sample. The method includes the steps of providing a reagent including sulfur dioxide and/or a reaction product of sulfur dioxide and an alcohol and/or an amine, and further includes a base, and a solvent; providing the sample including water; and titrating the sample with the reagent to determine the amount of water in the sample, wherein the reagent and/or the sample further includes a phenol compound chosen from dihydroxybenzene, butylhydroxytoluol, butylhydroxyanisol, 2,2,5,7,8-pentamethyl-6-chromanol, alpha-tocopherol, and combinations thereof.

An additional method is also provided, wherein the method further includes the step of adding a source of iodine to the reagent and/or the sample.

This disclosure further provides a method for determining an amount of water in a sample that includes water and xylene. This method utilizes a reagent that includes sulfur dioxide and/or the reaction product, and further includes diethylene glycol monoalkyl ether, and imidazole or a derivative thereof having the following structure (I):

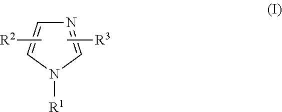

wherein each of R¹, R², and R³ is independently a hydrogen atom, a phenyl group, or a hydrocarbyl group, provided that R¹, R², and R³ are not all hydrogen atoms, and wherein the reagent and/or sample includes the phenol compound in an amount of from about 5 to about 5000 parts by weight per one million parts by weight of the reagent and/or the sample.

### BRIEF DESCRIPTION OF THE DRAWINGS

The present disclosure will hereinafter be described in conjunction with the following drawing figures, wherein

FIG. 1 is a collection of line graphs of drift, reported in the y-axis and in a unit of μg/min, as a function of time, reported in the x-axis and in a unit of s, collected from KF titrations of samples that include xylene, water, and optionally butylhydroxytoluol in concentrations of from about 0 to about 400 ppm;

FIG. 2 is a collection of line graphs of drift, reported in the y-axis and in a unit of μg/min, as a function of time, reported in the x-axis and in a unit of s, collected from KF titrations of samples that include xylene, water, and optionally 2,2,5,7,8-pentamethyl-6-chromanol in concentrations of from about 0 to about 400 ppm; and

FIG. 3 is a collection of line graphs of drift, reported in the y-axis and in a unit of μg/min, as a function of time, reported in the x-axis and in a unit of s, collected from KF titrations of samples that include xylene, water, and optionally alpha-tocopherol in in concentrations of from about 0 to about 400 ppm.

### DETAILED DESCRIPTION

The following detailed description is merely exemplary in nature and is not intended to limit the method or reagent. Furthermore, there is no intention to be bound by any theory presented in the preceding background or the following detailed description.

Embodiments of the present disclosure are generally directed to methods of titration and solutions for the same. For the sake of brevity, conventional techniques may not be described in detail herein. Moreover, the various tasks and process steps described herein may be incorporated into a more comprehensive procedure or process having additional steps or functionality not described in detail herein. In particular, various steps in titration are well-known and so, in the interest of brevity, many conventional steps will only be mentioned briefly herein or will be omitted entirely without providing the well-known process details. Various desirable features and characteristics of the present disclosure will become apparent from the subsequent detailed description of the disclosure and the appended claims, taken in conjunction with the accompanying drawings and the background of the disclosure.

As mentioned above, this disclosure provides a method for determining an amount of water in a sample. The method includes the steps of providing the reagent; providing the sample; and titrating the sample with the reagent to determine the amount of water in the sample.

The sample used in this method may be any sample known in the art that includes water. The sample may be present in various physical forms, e.g. solid, liquid, gas, or combinations thereof. The sample may be further described as an unknown, a test solution, a water standard, etc. The sample may also be provided from various sources, e.g. in-house and/or external sources.

Typically, the method can be described as a version or variant of a KF titration and can be used to determine an amount of water or moisture in a sample. There are generally two ways to perform the KF titration. The first type of KF titration is a volumetric KF titration. Volumetric titrations can be performed by introducing the sample into a titration cell. Subsequently, the reagent can be added to the titration cell such that the water in the sample is titrated. The reagent may include iodine that can react with the water in KF reactions. The titration may be monitored to detect an end point, which can occur when excess iodine is detected, indicating that all water in the sample has been consumed in the well-known KF reactions. In this titration, the determination of the amount of water in the sample can be based on an amount, or volume, of reagent, used to react with the water.

Typically, volumetric titrations can be performed to determine an amount of water of at least about 0.1 wt % and up to about 100 wt %, based on a total weight of the sample. In various embodiments, the volumetric titration may be used to titrate a sample that includes water in an amount of from about 0.1 to about 10 wt %, about 1 to about 10 wt %, about 1 to about 5 wt %, about 10 to about 90 wt %, about 20 to about 80 wt %, about 30 to about 70 wt %, about 40 to about 60 wt %, or about 40 to about 50 wt %, based on a total weight of the sample. In various non-limiting embodiments, it is also contemplated that all values and ranges of values, both whole and fractional, between and including those values set forth above are expressly contemplated for use herein.

The second type of KF titration is a coulometric KF titration. Coulometric titrations can be performed by introducing the sample and the reagent into the titration cell. Unlike volumetric KF titrations, iodine may not be included in the reagent and/or the sample prior to the titration. Rather, iodine can be generated and released into the titration cell by the induction of an electrical current, and subsequently react with the water in the sample. Because the iodine may be detected as soon as it is released, any excess iodine in the titration cell can be more accurately monitored. As such, the coulometric KF titration is typically used to accurately measure small amounts of water in the sample, e.g. from about 1 to about 1000 parts by weight per one million parts by weight of the sample.

In various embodiments, the coulometric titration may be used to titrate a sample that includes water in an amount of from about 100 to about 1000, about 100 to about 900, about 200 to about 800, about 300 to about 700, about 400 to about 600, or about 400 to about 500, parts by weight per one million parts by weight of the sample. In other embodiments, the coulometric titration may be used to titrate a sample that includes water in an amount of from about 1 to about 100, about 10 to about 90, about 20 to about 80, about 30 to about 70, about 40 to about 60, or about 40 to about 50, parts by weight per one million parts by weight of the sample. In various non-limiting embodiments, it is also contemplated that all values and ranges of values, both whole and fractional, between and including those values set forth above are expressly contemplated for use herein.

### Providing the Reagent:

Referring back, the method includes the step of providing the reagent. The step of providing may be any method known in the art and is not particularly limited. For example, the step of providing may be performed using various apparatuses and/or techniques, e.g. pouring the reagent, pipetting the reagent, pumping the reagent, into the titration cell, etc. The step of providing the reagent may be performed before, after, or concurrently with the step of providing the sample. For example, in volumetric KF titrations, it can be beneficial to provide the reagent after the step of providing the sample, e.g. to avoid over-titrating. However, in both volumetric and coulometric KF titrations, the reagent may be provided in any order relative to the sample.

Referring to the reagent itself, the reagent may be further described as a KF reagent, a KF solution, a titrant, a reagent solution, etc. The reagent can be used to titrate various samples using different KF methods, e.g. volumetric or coulometric titrations, or used as a one-component reagent or a two-component reagent, etc.

The reagent includes various components including sulfur dioxide and/or the reaction product of sulfur dioxide and an alcohol and/or an amine. The reagent further includes the base and the solvent. Additionally, the reagent may include a phenol compound. For example, if the phenol compound is not present in the sample, then the reagent includes the phenol compound. However, if the phenol compound is present in the sample, then the reagent may include, or be free of, the phenol compound.

The reagent may additionally include, or be free of, a source of iodine. In various embodiments, the reagent includes iodine and is further described as a one-component reagent. In other embodiments, the reagent is free of iodine and is further described as a two-component reagent.

The components of the reagent may be provided in any physical form, as would be understood by one of skill in the art, e.g. in gas phase, in liquid phase, in solid phase, as a solution, etc. or combinations thereof. The components may be combined in any partial or whole amount, or in any order as determined by one skilled in the art. Furthermore, the components may be combined using any method, apparatus, and/or any condition known in the art. For example, the base may first be combined with the solvent and/or iodine to form a mixture. The mixture can subsequently be placed in an ice bath and passed through with sulfur dioxide gas to form the reagent.

In various embodiments, the reagent can be used in an anode space and/or a cathode space of a coulometric two chamber cell or as a universal electrolyte in a single-chamber cell.

### Sulfur Dioxide:

As first introduced above, the reagent includes sulfur dioxide and/or a reaction product of sulfur dioxide and an alcohol and/or an amine. Typically, the sulfur dioxide and or the reaction product can be used in KF titrations to convert water into sulfurous acid. As understood by one of skill in the art, the reaction product may include, for example, sulfurous acid amide, sulfites such as dimethylsulfite, diethylsulfite, and combinations thereof. The reaction product can be present in the reagent as a result of sulfur dioxide reacting with an alcohol or an amine that is included in the reagent and/or the sample. Alternatively, the reagent and/or the sample can be free of the reaction product.

In various embodiments, the sulfur dioxide and/or the reaction product is present in an amount of from about 0.01 to about 5, mols per liter of the reagent. In other embodiments, the sulfur dioxide and/or the reaction product is present in an amount of from about 0.02 to about 4, about 0.03 to about 3, about 0.04 to about 2, about 0.05 to about 1, about 0.1 to about 1, about 0.1 to about 0.9, about 0.2 to about 0.9, about 0.2 to about 0.8, about 0.3 to about 0.7, about 0.4 to about 0.6, or about 0.1 to about 0.5, mols per liter of the reagent. In various non-limiting embodiments, it is also contemplated that all values and ranges of values, both whole and fractional, between and including those values set forth above are expressly contemplated for use herein.

### Base:

The reagent additionally includes the base. The base may be used to neutralize the sulfurous acid formed from the reaction of sulfur dioxide (SO₂) with water. The base may be any base known in the art that is suitable for Karl-Fischer titration. For example, the base may be a nitrogen containing base or may be a base that is free of nitrogen. In various embodiments, the base may be a primary, secondary, or tertiary amine. In alternative embodiments, the base may be pyridine or a derivative thereof.

In various embodiments, the base is or includes imidazole, a derivative thereof, or combinations thereof. The derivative of imidazole may have the following structure (I):

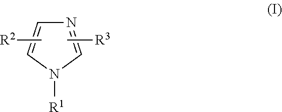

wherein each of R¹, R², and R³ is independently a hydrogen atom, a phenyl group, or a hydrocarbyl group, provided that R¹, R², and R³ are not all hydrogen atoms.

The phenyl group and/or the hydrocarbyl group may be any known in the art and are not particularly limited. For example, the phenyl group and/or the hydrocarbyl group may have various carbon chain lengths. In various embodiments, the phenyl group and/or the hydrocarbyl group has from 1 to 6 carbon atoms, e.g. 1, 2, 3, 4, 5, or 6, carbon atoms. The phenyl group and/or the hydrocarbyl group may be linear or branched, may include, or be free of, hetero atoms, e.g. nitrogen, oxygen, phosphorous, chlorine, bromine, iodine, etc., may include an aliphatic and/or an aromatic portion, etc.

In various embodiments, each of R¹, R², and R³ is independently a hydrogen atom, a methyl group, an ethyl group, a propyl group or a butyl group, provided that R⁶, R⁷, and R⁸ are not all hydrogen atoms.

In various embodiments, the reagent includes a molar ratio of the base to the sulfur dioxide and/or the reaction product that is greater than, or less than, 1:1. In various embodiments, the molar ratio of the base to the sulfur dioxide and/or the reaction product is about 1.5:1, about 2:1, about 2.5:1, about 3:1, about 3.5:1, about 4:1, about 4.5:1, about 5:1, about 5.5:1, about 6:1, about 6.5:1, about 7:1, about 7.5:1, about 8:1, about 8.5:1, about 9:1, about 9.5:1, about 10:1, about 10.5:1, about 11:1, about 11.5:1, about 12:1, about 12.5:1, about 13:1, about 13.5:1, about 14:1, about 14.5:1, about 15:1, about 15.5:1, about 16:1, about 16.5:1, about 17:1, about 17.5:1, about 18:1, about 18.5:1, about 19:1, about 19.5:1, or about 20:1. It is also contemplated that any of these molar ratios may be reversed thereby indicating that a molar ratio of the base to the sulfur dioxide and/or the reaction product is less than 1:1. In various non-limiting embodiments, it is also contemplated that all values and ranges of values, both whole and fractional, between and including those values set forth above are expressly contemplated for use herein.

In various embodiments, the base is present in the reagent in an amount of from about 0.1 to about 10, mols per liter of the reagent. In other embodiments, the base is present in an amount of from about 0.1 to about 1, about 0.2 to about 0.8, about 0.3 to about 0.7, about 0.4 to about 0.6, or about 0.4 to about 0.5, mols per liter of the reagent. In still other embodiments, the base is present in an amount of from about 1 to about 10, about 2 to about 9, about 3 to about 8, about 4 to about 7, or about 5 to about 6, mols per liter of the reagent. I in other embodiments, the base is present in an amount of from about 1 to about 2, about 1 to about 1.9, about 1 to about 1.8, about 1 to about 1.7, about 1 to about 1.6, or about 1 to about 1.5, mols per liter of the reagent. In various non-limiting embodiments, it is also contemplated that all values and ranges of values, both whole and fractional, between and including those values set forth above are expressly contemplated for use herein.

### Solvent:

Referring now to the solvent, the solvent may be any known in the art. The solvent may be or include a protic solvent, an aprotic solvent (polar protic or nonpolar aprotic), or combinations thereof.

In various embodiments, the solvent may be or include a protic solvent. The protic solvent may be any known in the art and can include an alcohol and/or amine. Non-limiting examples of protic solvents include alcohols such as methanol, ethanol, propanol, butanol, 1-methoxypropan-2-ol, mono- and di-ethylene glycol monoalkyl ethers, etc., or amines such as aniline, nitroaniline, pyrrole, and amides, etc.

In other embodiments, the solvent may be or include a polar aprotic solvent. Nonlimiting examples of polar aprotic solvents include dichloromethane, tetrahydrofuran, ethyl acetate, acetonitrile, dimethylforamide, dimethyl sulfoxide, acetone, propylene carbonate, etc.

In still other embodiments, the solvent may be or include a nonpolar aprotic solvent. Nonpolar aprotic solvents may be more commonly described as nonpolar solvents, and typically includes hydrocarbons, e.g. pentane, hexane, benzene, toluene, etc. and substituted hydrocarbons e.g. chloroform, diethyl ether, dioxane, etc.

In various embodiments, the solvent is chosen from xylene, acetonitrile, propionitrile, ethanol, methanol, propanol, butanol, propylene carbonate, 1-methoxypropan-2-ol, monoethylene glycol monoalkyl ether, diethylene glycol monoalkyl ether, and combinations thereof.

The solvent may be utilized in any amount as determined by one of skill in the art. For example, the solvent may be used in an amount to “balance” all other components of the reagent such that a total amount of all components of the reagent is about 100 wt %. Alternatively, the solvent may be used in an amount of from about 1 to about 99, about 5 to about 95, about 10 to about 90, about 15 to about 85, about 20 to about 80, about 25 to about 75, about 30 to about 70, about 35 to about 65, about 40 to about 60, about 45 to about 55, about 50 to about 55, about 1, 2, 3, 4, 5, 6, 7, 8, 9, or 10, or about 90, 91, 92, 93, 94, 95, 96, 97, 98, or 99, wt %, based on a total weight of the reagent. In various non-limiting embodiments, it is also contemplated that all values and ranges of values, both whole and fractional, between and including those values set forth above are expressly contemplated for use herein.

### Providing the Sample:

The method also includes the step of providing the sample. The step of providing may be any method known in the art and is not particularly limited. For example, the step may be performed using various apparatuses and/or techniques, e.g. pouring the sample, pipetting the sample, pumping the sample, into the titration cell, etc. The step of providing the sample may be performed before, after, or concurrently with the step of providing the reagent.

As first introduced above, the sample includes water. The sample may further include, or be free of, the phenol compound. The phenol compound may be combined with other components of the sample at various time points, e.g. less than about 1 h before titration, less than about a day before titration, less than about 1 week before titration, less than about 1 month before titration, less than about a year before titration, etc.

The sample includes water that may be present in various amounts to be determined by the titration. The amount of water is not particularly limited and may be chosen by one of skill in the art. For example, in coulometric titrations, the amount of water in the sample may be from about 0.1 to about 10000 μg of water, about 0.1 to about 3000 μg, about 20 to about 3000 μg of water, or about 1 to about 10000 μg of water. In volumetric titrations, the amount of water can greatly exceed 10 mg, e.g. from about 100 μg to about 100 mg, about 500 μg to about 1 mg, about 1 mg to about 100 mg, etc. In still other embodiments, the maximum amount of water is determined by the size of the titration cell used because of the amount of the reagent that would be required. In various non-limiting embodiments, it is also contemplated that all values and ranges of values, both whole and fractional, between and including those values set forth above are expressly contemplated for use herein.

In various embodiments, the sample may not be soluble or dissolvable in the KF reagent. Accordingly, in some embodiments, the sample may include, or be free of, an additional solvent, which is not particularly limited and may be any known in the art. The additional solvent may be used to distribute the water in KF reactions. Alternatively, the additional solvent may be used to dissolve solids or gases in the sample.

Depending on the type and source of the sample, the additional solvent may be the same as, or different from, the solvent in the reagent. The additional solvent may be or include a protic solvent, an aprotic solvent (polar protic or nonpolar aprotic), or combinations thereof, as first described above.

In various embodiments, the additional solvent is chosen from xylene, acetonitrile, propionitrile, ethanol, methanol, propanol, butanol, propylene carbonate, 1-methoxypropan-2-ol, monocthylene glycol monoalkyl ether, diethylene glycol monoalkyl ether, and combinations thereof. In various embodiments, the sample includes water and xylene. In other embodiments, the sample includes water and butanol.

The additional solvent may be utilized in any amount as determined by one of skill in the art. For example, the additional solvent may be used in an amount to “balance” other components of the sample such that a total amount of all components of the reagent is about 100 wt %. Alternatively, the additional solvent may be used in an amount of from about 1 to about 99, about 5 to about 95, about 10 to about 90, about 15 to about 85, about 20 to about 80, about 25 to about 75, about 30 to about 70, about 35 to about 65, about 40 to about 60, about 45 to about 55, about 50 to about 55, about 1, 2, 3, 4, 5, 6, 7, 8, 9, or 10, or about 90, 91, 92, 93, 94, 95, 96, 97, 98, or 99, wt %, based on a total weight of the sample. In various non-limiting embodiments, it is also contemplated that all values and ranges of values, both whole and fractional, between and including those values set forth above are expressly contemplated for use herein.

### Phenol Compound:

The reagent and/or the sample includes the phenol compound. The phenol compound may be used in KF titrations, the reagent, and/or the sample as a stabilizer, an accelerator, an additive, a preservative, to improve KF reactions, to stabilize and/or accelerate drift time of the titration, to prolong shelf life of the reagent and/or sample, to treat the water, to form a water standard, etc.

The phenol compound is chosen from dihydroxybenzene, butylhydroxytoluol, butylhydroxyanisol, 2,2,5,7,8-pentamethyl-6-chromanol, alpha-tocopherol, and combinations thereof. In various embodiments, the phenol compound is or includes butylhydroxytoluol. In other embodiments, the phenol compound is or includes 2,2,5,7,8-pentamethyl-6-chromanol. In yet other embodiments, the phenol compound is or includes alpha-tocopherol.

The reagent and/or the sample may include, or be free of, an additional phenol compound that is different from the phenol compound first described above. For example, in various embodiments, the reagent and/or the sample additionally includes di-tert-butylphenol.

The phenol compound can be used in small quantities, e.g. from about 5 to about 5000 parts by weight per one million parts by weight of the reagent and/or the sample. However, excessive amount of the phenol compound, e.g. greater than about 5000 parts by weight per one million parts by weight of the reagent and/or the sample, may lead to unstable and/or dragging titration end-points. Without being bound by theory, it is believed that the unstable and/or dragging titration end-points may be caused by a side reaction, namely the oxidation of the phenol compound by iodine that is present in KF titrations.

In various embodiments, the phenol compound is present in the reagent and the reagent may be further described as a stabilized reagent. The phenol compound may be present in the reagent in an amount of from about 5 to about 5000 parts by weight per one million parts by weight of the reagent. The amount of the phenol compound in the reagent may depend on the application of the reagent, e.g. used as a concentrate or a working solution, or used in a volumetric or a coulometric titration, and/or the phenol compound itself. In various embodiments, the phenol compound is present in the reagent in an amount of from about 5 to about 50, about 10 to about 45, about 15 to about 40, about 20 to about 35, or about 25 to about 30, parts by weight per one million parts by weight of the reagent. In other embodiments, the phenol compound is present in an amount of from about 50 to about 500, about 60 to about to about 450, about 70 to about 400, about 80 to about 350, about 90 to about 300, about 100 to about 200, or about 50 to about 200, parts by weight per one million parts by weight of the reagent. In yet other embodiments, the phenol compound is present in an amount of from about 500 to about 5000, about 1000 to about 4500, about 1500 to about 4000, about 2000 to about 3500, or about 2500 to about 3000, parts by weight per one million parts by weight of the reagent. In various non-limiting embodiments, it is also contemplated that all values and ranges of values, both whole and fractional, between and including those values set forth above are expressly contemplated for use herein.

In various other embodiments, the phenol compound is present in the sample and the sample may be further described as a treated sample, a water standard, a KF standard, a KF sample, etc. The phenol compound may be present in the sample in an amount of from about 5 to about 5000 parts by weight per one million parts by weight of the sample. The amount of the phenol compound in the sample may depend on the application of the sample, e.g. treating the sample, forming a water standard, stabilizing the sample for storage of at least about 1 day, at least about 1 week, at least about 10 weeks, at least about 20 weeks, at least about 1 year, etc. In various embodiments, the phenol compound is present in the sample in an amount of from about 5 to about 50, about 10 to about 45, about 15 to about 40, about 20 to about 35, or about 25 to about 30, parts by weight per one million parts by weight of the sample. In other embodiments, the phenol compound is present in an amount of from about 50 to about 500, about 60 to about to about 450, about 70 to about 400, about 80 to about 350, about 90 to about 300, about 100 to about 200, or about 50 to about 200, parts by weight per one million parts by weight of the sample. In yet other embodiments, the phenol compound is present in an amount of from about 500 to about 5000, about 1000 to about 4500, about 1500 to about 4000, about 2000 to about 3500, or about 2500 to about 3000, parts by weight per one million parts by weight of the sample. In various non-limiting embodiments, it is also contemplated that all values and ranges of values, both whole and fractional, between and including those values set forth above are expressly contemplated for use herein.

In various embodiments, the phenol compound is present in both the reagent and the sample, each in an amount as described above.

### Adding a Source of Iodine:

The method may further include, or be free of, the step of adding a source of iodine to the reagent and/or the sample. The source of iodine and the step of adding may vary depending on whether the titration is volumetric or coulometric. For example, in volumetric titrations, the step of adding may be performed manually, e.g. by delivering the iodine (as solids or as a solution) into the reagent and/or the sample. Alternatively, in coulometric titrations, the step of adding may be described as forming the iodine electrochemically inside the titration cell. More specifically, in coulometric titration, iodide ions, typically provided in a salt and/or acid solution, e.g. solution of hydriodic acid, solution of lithium iodide salt, solution of potassium iodide salt, etc., can be oxidized to generate iodine in-situ at the anode of the titration cell.

In various embodiments, the iodine is present in the reagent and/or the sample in an amount of from about 1 to about 10, about 2 to about 9, about 3 to about 8, about 4 to about 7, or about 5 to about 6, wt % of the combination of the reagent and the sample. In various non-limiting embodiments, it is also contemplated that all values and ranges of values, both whole and fractional, between and including those values set forth above are expressly contemplated for use herein.

During the titration, the added or anodically generated iodine can be reduced by the reaction with the sulfur dioxide. At the end of the titration, when there is no more water to react, there may be free iodine present as left over. The iodine excess can be used for indicating the titration end point, e.g. for visual and/or photometric indication. It is also possible to indicate the titration end point electrochemically, e.g. bipotentiometrically or biamperometrically.

### Additional Components:

The reagent and/or the sample may further include, or be free of, additional components, e.g. to limit side reactions, to study the effect of the phenol compound, to improve KF reaction conditions, etc.

In various embodiments, the reagent and/or sample includes a buffer. Depending on the particular sample and any signal interferences, the buffer may be used to stabilize the pH of the reagent and/or sample at a pH of about 5 to about 9. In various embodiments, the pH is from about 5 to about 7, about 5.5 to about 6.5, about 6 to about 7, or about 5 to about 6. In other embodiments, the pH is from about 7 to about 9, about 7.5 to about 8.5, about 8 to about 9, or about 7 to about 8. In various non-limiting embodiments, it is also contemplated that all values and ranges of values, both whole and fractional, between and including those values set forth above are expressly contemplated for use herein.

The buffer may be provided in any physical form, e.g. as a solid, as a liquid, as a solution, etc. Non-limiting examples of buffers include formamide, benzoic acid, diethanolamine, triethanolamine, morpholine, boric acid, etc.

In coulometric titrations, the reagent and/or sample may include, or be free of, an electrolyte, e.g. to enhance conductivity and/or the electrochemical generation of iodine. In various embodiments, a lithium salt, e.g. lithium chloride, lithium bromide, etc. is used. In other embodiments, an organic salt, e.g. tetrabutylammonium chloride, imidazolium hydrogen bromide, etc. is used. In various embodiments, the electrolyte may be used if the reagent has a conductivity of from about 5 to about 20 mS/cm, e.g. about 5 to about 15 mS/cm, about 5 to about 10 mS/cm, about 10 to about 20 mS/cm, etc. In various non-limiting embodiments, it is also contemplated that all values and ranges of values, both whole and fractional, between and including those values set forth above are expressly contemplated for use herein.

The reagent and/or sample may also include, or be free of, a compound that has a known reproducible titration end point, e.g. to serve as an internal control. This control compound may be chosen by one of skill in the art. In various embodiments, the method may include, or be free of, one or more of the compounds, method steps, etc. as set forth in U.S. Pat. No. 5,401,662, which is expressly incorporated herein by reference in its entirety in various non-limiting embodiments.

### Titration:

Referring back, the method includes the step of titrating. As first described above, the titration can be carried out as a volumetric titration or as a coulometric titration. The titration cell is not particularly limited and may be any known in the art. In various embodiments, the titration is performed in a titration cell, such as a cell in a Metrohm 852 Titrando. The titration cell may be airtight. Additionally, the titration cell may be further isolated from the ambient atmosphere, e.g. by being placed inside a glove box, by using moisture-absorbing resins, by purging the titration cell with a dry inert gas, e.g. nitrogen or argon, etc.

Typically, the step of titrating may vary depending on various factors, e.g. using volumetric or coulometric titration, using a one-component or two-component reagent, etc. Titrations utilizing a one-component reagent may be performed by adding the sample to the titration cell. This titration cell may be empty prior to the step of adding the sample. Alternatively, this titration cell may include an additional solvent and/or a partial amount of the one-component reagent prior to adding the sample, e.g. to more effectively distribute the sample in the titration cell. Subsequently, the one-component reagent is added to the titration cell such that the titration can begin.

Titrations utilizing a two-component reagent may be also performed by adding the sample to the titration cell. Again, this titration cell may be empty prior to the step of adding the sample. Alternatively, this titration cell may include an additional solvent and/or an iodine-free component of the two-component reagent prior to adding the sample, e.g. also to effectively distribute the sample in the titration cell. Then, an iodine-containing component of the two-component reagent may be added to begin the titration.

Alternatively, coulometric titrations can be performed, for example, by delivering the reagent, the sample, and iodide ions, into the titration cell. Then, the iodide ions can be converted into iodine electrochemically and released into the titration cell to react with the water in the sample, thereby beginning the titration.

The step of titrating may further include the step of conditioning the reagent, the solvent and/or the titration cell. Prior to determining the amount of water in the sample, water present in the solvent and/or the titration cell can be removed in a blank titration. This blank titration may be known in the art as conditioning. The step of conditioning may be performed until a stable and low drift is acquired.

The terminology “drift” describes the change in the amount of water in the sample over time. Drift can affect the accuracy and precision of the water content measurement of the sample. When the drift is stabilized, e.g. at less than or equal to about 20 μg per minute for coulometric titrations, or at less than or equal to about 20 μL per minute for volumetric titrations, the determination of the amount of water in the sample may begin. When the drift is not stabilized, an accurate water determination may not be obtained. Additionally, drift values exceeding the previous described values may indicate the presence of a leak where ambient moisture can enter the titration cell, and undesirably inflating the measured water content.

In a coulometric method, the stable drift value may be less than or equal to about 20 μg per minute, e.g. less than about 15 μg per minute, less than about 10 μg per minute, less than about 5 μg per minute, etc. In a volumetric method, the stable drift value may be less than or equal to about 20 μL per minute, e.g. less than about 15 μL per minute, less than about 10 μL per minute, less than about 5 μL per minute, etc. In various non-limiting embodiments, it is also contemplated that all values and ranges of values, both whole and fractional, between and including those values set forth above are expressly contemplated for use herein.

As first described above, the phenol compound may be used to stabilize drift signals and/or accelerate the time to stabilize the drift, or stable drift time. In various embodiments, the method further includes the step of monitoring the drift. By performing the step of monitoring, both stable drift time and stable drift value may be measured. Accordingly, the step of monitoring the drift may be further described as measuring the stable drift time and/or measuring the stable drift value. As the drift can also be measured in millivolt (mV) per minute, a stable drift can be identified by lack of drift changes, or changes of less than about 1 mV per minute, e.g. less than about 0.5 mV per minute, less than about 0.1 mV per minute. In various non-limiting embodiments, it is also contemplated that all values and ranges of values, both whole and fractional, between and including those values set forth above are expressly contemplated for use herein.

In various embodiments, the stable drift time is less than or equal to about 300 s. In other embodiments, the stable drift time is less than about 250 s, less than about 240 s, less than about 230 s, less than about 220 s, less than about 210 s, less than about 200 s, less than about 190 s, less than about 180 s, less than about 170 s, less than about 160 s, or less than about 150 s. In various non-limiting embodiments, it is also contemplated that all values and ranges of values, both whole and fractional, between and including those values set forth above are expressly contemplated for use herein.

Without being bound by theory, it is believed that the phenol compound can shorten the drift time by affecting the kinetics and/or the thermodynamics of KF reactions, e.g. by lowering the reaction activation barrier of the KF titration reactions. It is contemplated that the phenol compound, which can be described as an aromatic alcohol, can be more acidic than aliphatic alcohols typically used in KF reagents, e.g. methanol, and can react more readily with sulfur dioxide allowing for a faster reaction time.

Relative to the possible effect of the phenol compound on the thermodynamics of KF reactions, it is also contemplated that the reaction product of the phenol compound with the sulfur dioxide and the base can lower the activation barrier of the KF reactions. This lower activation barrier can facilitate more efficient KF reactions and can shorten the overall stable drift time and improve accuracy and efficiency of KF titrations.

### EXAMPLES

A series of Examples and Comparative Examples (CE's) are evaluated in coulometric titrations. More specifically, Examples 2-5, 7-10, 12-15, and CE's 1, 6, 11 involve titrations of samples of 10 mL each with a water content of about 55±5 ppm using a Metrohm 852 Titrando apparatus. The samples used in the Examples and the CE's include xylene and the phenol compound in amounts as described in Table 1 below. Before performing the titrations, the samples were allowed to rest for about 4 weeks at an elevated temperature of about 50° C.

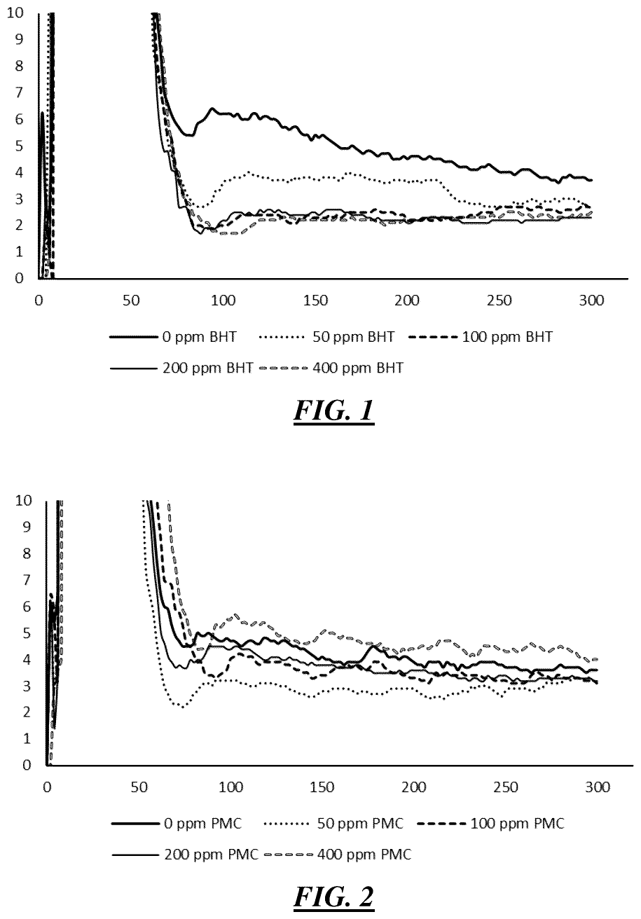

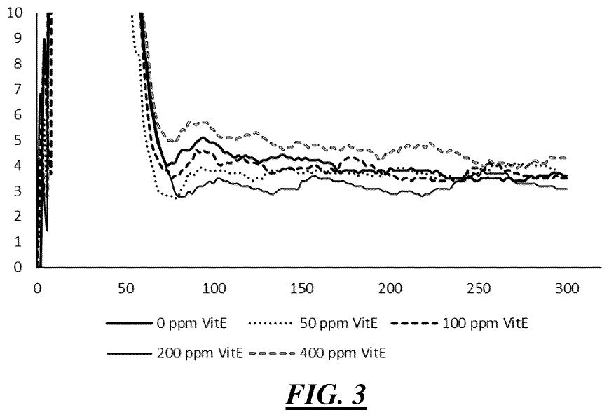

These Examples examine the reduction in stable drift time of the KF titrations using various phenol compounds. The time that is required to achieve a stable drift is set forth in Table 1. The stable drift can be identified using the line graphs of drift vs. time, which are illustrated in FIGS. 1-3.

Formation of an oxidation product of xylene, methylbenzaldehyde, was detected. Measuring the amount of methylbenzaldehyde can be useful in monitoring any anti-oxidation behavior or lack thereof of the phenol compound. The methylbenzaldehyde contents are also set forth in Table 1.

TABLE 1
Components and Stable Drift Time of
Compositions and Counter Examples.

| | | | | Stable |
|---|---|---|---|---|
| | Phenol Compound | | Methyl | Drift |
| | Chemical | Conc. | benzaldehyde | Time |
| Composition | Name | (ppm) | (ppm) | (s) |
| CE 1 | Butyl | 0 | 21 | >300 |
| 2 | hydroxytoluol | 50 | ≤1 | >300 |
| 3 | | 100 | ≤1 | 130 |
| 4 | | 200 | ≤1 | 130 |
| 5 | | 400 | ≤1 | 130 |
| CE 6 | 2,2,5,7,8- | 0 | 15 | >300 |
| 7 | Pentamethyl- | 50 | ≤1 | 130 |
| 8 | 6-Chromanol | 100 | ≤1 | 250 |
| 9 | | 200 | ≤1 | 300 |
| 10 | | 400 | 2 | >300 |
| CE 11 | alpha- | 0 | 18 | 240 |
| 12 | tocopherol | 50 | ≤1 | 130 |
| 13 | | 100 | ≤1 | 200 |
| 14 | | 200 | 2 | 300 |
| 15 | | 400 | 2 | >300 |

The data set forth above shows that, in the absence of the phenol compound, the drift is generally stabilized after more than 300 s. However, in the presence of the phenol compound, the drift is stabilized in a shorter amount of time, e.g. less than or equal to about 300 s. More specifically, when the phenol compound is butylhydroxytoluol, the stable drift time is reduced to below 300 s when the butylhydroxytoluol is present in an amount of from 100 to about 400 ppm. When the phenol compound is 2,2,5,7,8-Pentamethyl-6-Chromanol or alpha-tocopherol, the stable drift time is reduced to below 300 s when the phenol compound is present in an amount of from 50 to about 100 ppm.

As shown in Examples 2-5, 7-10, 12-15, the amount of methylbenzaldehyde remains relatively stable, e.g. from about 1 to about 2 ppm, when the type and the amount of the phenol compound are varied. This observation suggests that the phenol compound exhibits some anti-oxidation effect. However, the methylbenzaldehyde concentration does not appear to correlate with the drift reduction ability of the phenol compound. This observation clearly shows that the phenol compound can lower the stable drift time and/or improve the titrations via a mechanism different from anti-oxidation effect.

Overall, the Examples that include the phenol compound show superior KF titration performances, e.g. shorter stable drift time, over the CE's that are free of the phenol compound. More specifically, the drift stabilization effect of butylhydroxytoluene can be observed at elevated concentrations of from about 100 to about 400 ppm. However, the drift stabilization effect of 2,2,5,7,8-Pentamethyl-6-Chromanol and alpha-tocopherol can be observed at low concentrations of from about 50 ppm to about 100 ppm. The results are also unexpected because the methylbenzaldehyde concentration does not appear to correlate with the drift reduction ability of the phenol compound, suggesting a unique mechanism by which the phenol compound uses to improve the performance of KF titrations.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration in any way. Rather, the foregoing detailed description will provide those skilled in the art with a convenient road map for implementing an exemplary embodiment. It being understood that various changes may be made in the function and arrangement of elements described in an exemplary embodiment without departing from the scope as set forth in the appended claims.

What is claimed is:

1. A method for determining an amount of water in a sample, said method comprising the steps of:
A. providing a reagent comprising sulfur dioxide and/or a reaction product of sulfur dioxide and an alcohol and/or an amine; and further comprising a base; and a solvent;
B. providing the sample comprising water; and
C. titrating the sample with the reagent to determine the amount of water in the sample;
wherein the reagent and/or the sample further comprises a phenol compound chosen from dihydroxybenzene, butylhydroxytoluol, butylhydroxyanisol, 2,2,5,7,8-pentamethyl-6-chromanol, alpha-tocopherol, and combinations thereof.

2. The method of claim 1 wherein the reagent and/or the sample further comprises di-tert-butylphenol.

3. The method of claim 1 wherein the phenol compound is present in the reagent and/or the sample in an amount of from about 5 to about 5000 parts by weight per one million parts by weight of the reagent and/or the sample, respectively.

4. The method of claim 1 wherein the sulfur dioxide and/or the reaction product is present in an amount of from about 0.01 to about 5 mols per liter of the reagent.

5. The method of claim 1 wherein the base is imidazole and/or a derivative thereof having the following structure (I): 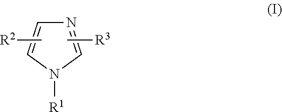
wherein each of R¹, R², and R³ is independently a hydrogen atom, a phenyl group, or a hydrocarbyl group, provided that R¹, R², and R³ are not all hydrogen atoms.

6. The method of claim 5 wherein each of R¹, R², and R³ is independently a hydrogen atom, a methyl group, an ethyl group, a propyl group or a butyl group, provided that R¹, R², and R³ are not all hydrogen atoms.

7. The method of claim 1 wherein the base is present in an amount of from about 0.1 to about 10 mols per liter of the reagent.

8. The method of claim 1 wherein the solvent is chosen from xylene, acetonitrile, propionitrile, ethanol, methanol, propanol, butanol, propylene carbonate, 1-methoxypropan-2-ol, monoethylene glycol monoalkyl ether, diethylene glycol monoalkyl ether, and combinations thereof.

9. The method of claim 1 wherein the solvent is diethylene glycol monoalkyl ether and the sample further includes an additional solvent that is chosen from xylene, butanol, and combinations thereof.

10. The method of claim 1 wherein:
the sulfur dioxide and/or the reaction product is present in the reagent in an amount of from about 0.2 to about 0.9 mols per liter of the reagent;
the base is present in the reagent in an amount of from about 1 to about 1.8 mols per liter of the reagent; and
the solvent is present in the reagent in an amount that makes up the weight balance of the reagent.

11. The method of claim 1 wherein the phenol compound is butylhydroxytoluol and is present in the reagent and/or the sample in an amount of from about 100 to about 400 parts by weight per one million parts by weight of the reagent and/or the sample, respectively.

12. The method of claim 1 wherein the phenol compound is 2,2,5,7,8-pentamethyl-6-chromanol and is present in the reagent and/or the sample in an amount of from about 50 to about 100 parts by weight per one million parts by weight of the reagent and/or the sample, respectively.

13. The method of claim 1 wherein the phenol compound is alpha-tocopherol and is present in the reagent and/or the sample in an amount of from about 50 to about 100 parts by weight per one million parts by weight of the reagent and/or the sample, respectively.

14. The method of claim 1 further comprising the step of measuring a stable drift time of the combination of the reagent and the sample and wherein the stable drift time is less than or equal to about 300 s.

15. The method of claim 1 that is a volumetric method and that further comprises the step of measuring a stable drift value of the combination of the reagent and the sample and wherein the stable drift value is less than or equal to about 20 μL of water per minute.

16. The method of claim 1 that is a coulometric method and that further comprises the step of measuring a stable drift value of the combination of the reagent and the sample and wherein the stable drift value is less than or equal to about 20 μg of water per minute.

17. A method for determining an amount of water in a sample, said method comprising the steps of:
A. providing a reagent comprising sulfur dioxide and/or a reaction product of sulfur dioxide and an alcohol and/or an amine; and further comprising a base; and a solvent;
B. providing the sample comprising water;
C. adding a source of iodine to the reagent and/or the sample; and
D. titrating the sample with the reagent to determine the amount of water in the sample;
wherein the reagent and/or the sample further comprises a phenol compound chosen from dihydroxybenzene, butylhydroxytoluol, butylhydroxyanisol, 2,2,5,7,8-pentamethyl-6-chromanol, alpha-tocopherol, and combinations thereof.

18. The method of claim 17 wherein the reagent and/or the sample further comprises di-tert-butylphenol.

19. A method for determining an amount of water in a sample, said method comprising the steps of:
A. providing a reagent comprising sulfur dioxide and/or a reaction product of sulfur dioxide and an alcohol and/or an amine; and further comprising diethylene glycol monoalkyl ether, and imidazole or a derivative thereof having the following structure (I): 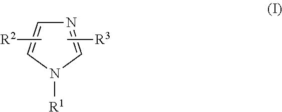
wherein each of R¹, R², and R³ is independently a hydrogen atom, a phenyl group, or a hydrocarbyl group, provided that R¹, R², and R³ are not all hydrogen atoms;
B. providing the sample comprising water and xylene; and
C. titrating the sample with the reagent to determine the amount of water in the sample;
the reagent and/or the sample further comprises a phenol compound chosen from dihydroxybenzene, butylhydroxytoluol, butylhydroxyanisol, 2,2,5,7,8-pentamethyl-6-chromanol, alpha-tocopherol, and combinations thereof; and
wherein the phenol compound is present in the reagent and/or the sample and in an amount of from about 5 to about 5000 parts by weight per one million parts by weight of the reagent and/or the sample.

20. The method of claim 19 wherein the reagent and/or the sample further comprises di-tert-butylphenol.
